(19) United States
(12) Patent Application Publication
(10) Pub. No.: US 2017/0349850 A1
(43) Pub. Date: Dec. 7, 2017

(54) LUBRICATING COMPOSITION WITH PHASE-CHANGE MATERIAL

(71) Applicant: TOTAL MARKETING SERVICES, Puteaux (FR)

(72) Inventors: Olivier LERASLE, Paris (FR); Severine THEVENET, Vaux en Beaujolais (FR); Julien GUERIN, Villeurbanne (FR); Fanny BRIAND, Lyon (FR)

(21) Appl. No.: 15/538,973

(22) PCT Filed: Dec. 22, 2015
(86) PCT No.: PCT/EP2015/080909

§ 371 Date: Jun. 22, 2017

(30) Foreign Application Priority Data
Dec. 23, 2014 (FR) 1463193

(51) Int. Cl. C10M 107/34; C10M 169/04; C09K 5/04; C10M 125/14

(52) U.S. Cl. CPC C10M 107/34; C10M 125/14; C10M 169/04; C09K 5/048; C10M 2209/1075; C10N 2230/04; C10N 2240/10; C10M 2201/02

(57) ABSTRACT

Disclosed is a monophasic lubricating composition including a base oil, an oil chosen from the polyalkylene glycols (PAG) and a phase-change material, in particular water. The monophasic lubricating composition can be used, in particular, for lubricating a vehicle engine. It has improved thermal performance relative to the lubricant compositions of the prior art. It also helps reduce fouling of the engine parts.

The invention concerns the field of lubricants and provides a monophasic lubricating composition comprising a base oil, an oil selected from among polyalkylene glycols (PAGs) and a phase-change material, particularly water. The monophasic lubricating composition of the invention is used for the lubrication of motor vehicle engines. It has improved thermal performance compared with prior art lubricating compositions. It also provides reduced fouling of engine parts.

Developments in engines and the performance of engine lubricating compositions are inextricably linked. The more engine design becomes complex, the higher the yield and optimisation of consumption, and the greater the demand placed on engine lubricating compositions for which performance must be improved.

Very high compression inside engines, higher piston temperatures in particular in the segment portion of the upper piston, modern maintenance-free valve controls with hydraulic plungers, and very high temperatures in the engine space constantly place increasing demand on lubricants for modern engines.

The conditions of use of petrol engines and diesel engines include both extremely short trips and long distances. The journeys travelled by 80% of motor vehicles in Western Europe cover less than 12 kilometres, whereas vehicles clock up annual mileages of up to 300 000 km.

Oil change intervals are also most variable, being 5 000 km for some small diesel engines and may extend to 100 000 km for diesel engines of modern commercial vehicles.

Lubricating compositions, and in particular lubricating compositions for motor vehicle engines, must therefore have improved properties and performance levels.

One problem encountered when using known lubricating compositions concerns the degradation and coking of the oils or additives used. These degradation and coking phenomena may lead to clogging of the lubricated parts, in particular inside a vehicle engine.

It is therefore necessary to provide lubricating compositions allowing an improvement in engine cleanliness. The improvement of engine cleanliness generally comprises reduced formation of deposits, in particular the formation of deposits at high temperatures such as varnishes, paints, carbon or coke deposits. Such deposits may form on hot surfaces of engine parts such as the bottom of piston grooves or turbocharger shafts. The substances contained in lubricating compositions may oxidize in contact with hot engine surfaces and generate the formation of insoluble products forming deposits. These deposits may foul the engine and cause problems of wear, seizure, sticking of segments and problems related to turbocharger rotation for example. In general, additives of detergent type of used to improve engine cleanliness.

Lubricating compositions are therefore needed with which it is possible efficiently to combat these phenomena, and in particular lubricating compositions need to be provided having improved heat resistance properties.

It is also necessary to provide lubricating compositions which can lower the temperature of the epilamen (film or skin of a lubricating composition) on lubricated mechanical parts of an engine and in particular on the pistons. To have available lubricating compositions which can lower the temperature of contacting parts e.g. inside a motor vehicle engine would therefore be particularly advantageous.

Lubricating compositions allowing absorption of part of the heat produced by an engine in operation are therefore needed.

It has now been found that the use of a phase-change material in combination with oils can allow absorption of part of the heat produced during lubrication, in particular inside a working engine, and thereby allow lowering of the temperature to which the oils and additives used are subjected.

In addition, the stability of lubricating compositions must also be ensured, in particular when used to lubricate an engine. Apart from the heat inside an engine, lubricating compositions undergo major mechanical stresses, shear stresses in particular.

For lack of being sufficiently stable, oils and additives of lubricating compositions may separate or degrade and lose all or part of their properties. In particular, lubricating compositions comprising different phases e.g. emulsions may be degraded and lead to separation of the oils and additives. When such separation occurs, particularly of emulsions contained in lubricating compositions, some elements or additives may deposit on the lower parts of the engine for example. Lubricating compositions thus degraded may lose their properties and lead to accelerated degradation of oils and additives, resulting in increased fouling of engine parts.

There is therefore a need for engine lubricating compositions which have improved performance levels and particularly allow the limiting or avoiding of coking and clogging problems.

The invention therefore provides a monophasic lubricating composition which brings a solution to all or part of the problems of prior art lubricating compositions.

The present invention concerns the use of a monophasic lubricating composition comprising a base oil, an oil selected from among polyalkylene glycols (PAGs) and 0.1 to 5% by weight of a phase-change material relative to PAG weight.

The lubricating composition is monophasic, translating in the composition as a low content of phase-change material, notably water, contained in an amount of 0.1 to 5 weight relative to PAG weight. It therefore comprises a single phase and differs from an emulsion. Therefore, the monophasic lubricating composition of the invention is able to undergo mechanical stresses, in particular shear stresses, without the risk of separation between the oils and the phase-change material.

Also preferably, the phase-change material and the oil selected from among PAGs in the composition of the invention may be in the form of a mixture. More preferably, the phase-change material and the oil selected from among PAGs may be in the form of a solution in the composition of the invention.

According to the invention, the PAG in the composition of the invention may be a block polymer or a statistical polymer.

The PAG of the invention comprises alkyl groups having hydrocarbon chains the length of which may vary. According to the invention, the length of the hydrocarbon chains is defined by a mean value of the number of carbon atoms.

Preferably, the PAG of the composition of the invention is a block polymer of formula (I) or a statistical polymer of formula (I):

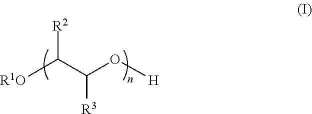

where:
R¹ is a straight-chain or branched C₁-C₃₀-alkyl group, preferably a straight-chain or branched C₈-C₁₂-alkyl group;
n is an integer ranging from 2 to 60, preferably 5 to 30 or 7 to 15;
R² and R³, the same or different, are each independently a hydrogen atom or C₁-C₂-alkyl group.

For the PAG of the invention, n may represent an integer ranging from 2 to 60, preferably ranging from 5 to 30 or from 7 to 15.

For a preferred PAG of the invention, R¹ is a straight-chain or branched C₈-C₁₂-alkyl group, R² and R³ are different and are each independently a hydrogen atom or straight-chain C₁-C₂-alkyl group, and n is an integer ranging from 7 to 15.

Also preferably, the PAG of the composition of the invention is a block polymer of formula (IA) or a statistical polymer of formula (IA):

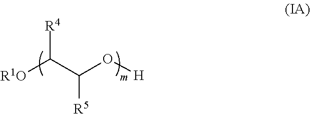

where:
R¹ is a straight-chain or branched C₁-C₃₀-alkyl group, preferably a straight-chain or branched C₈-C₁₂-alkyl group;
m is an integer ranging from 2 to 60, preferably from 5 to 30 or 7 to 15;
R⁴ and R⁵ are a hydrogen atom; or R⁴ is a hydrogen atom and R⁵ is a methyl group; or R⁴ is a methyl group and R⁵ is a hydrogen atom; or R⁴ and R⁵ are a methyl group; or R⁴ is an ethyl group and R⁵ is a hydrogen atom; or R⁴ is a hydrogen atom and R⁵ is an ethyl group.

For the PAG of the invention, m may represent an integer ranging from 2 to 60, preferably ranging from 5 to 30 or 7 to 15.

For a preferred PAG of the invention, R¹ is a straight-chain or branched C₈-C₁₂-alkyl group, R⁴ and R⁵ are different and are each independently a hydrogen atom, a methyl group or an ethyl group, and m is an integer ranging from 7 to 15.

Also preferably, the PAG of the composition of the invention is a block polymer of formula (IB) or a statistical polymer of formula (IB):

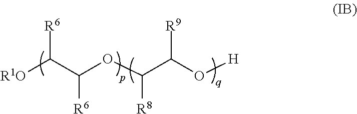

where:
R¹ is a straight-chain or branched C₁-C₃₀-alkyl group, preferably a straight-chain or branched C₈-C₁₂-alkyl group;
p and q are each independently an integer ranging from 1 to 30, preferably from 2 to 15 or 2 to 8;
R⁶ and R⁷ are a hydrogen atom; or R⁶ is a hydrogen atom and R⁷ is a methyl group; or R⁶ is a methyl group and R⁷ is a hydrogen atom; or R⁶ and R⁷ are a methyl group; or R⁶ is an ethyl group and R⁷ is a hydrogen atom; or R⁶ is a hydrogen atom and R⁷ is an ethyl group;
R⁸ and R⁹ are a hydrogen atom; or R⁸ is a hydrogen atom and R⁹ is a methyl group; or R⁸ is a methyl group and R⁹ is a hydrogen atom; or R⁸ and R⁹ are a methyl group; or R⁸ is an ethyl group and R⁹ is a hydrogen atom; or R⁸ is a hydrogen atom and R⁹ is an ethyl group.

For the PAG of the invention, p and q may each independently represent an integer ranging from 1 to 30, preferably from 2 to 15 or 2 to 8.

As particular PAGs of the invention, the following can be cited:
PAGs in which R⁶, R⁷, R⁸ and R⁹ are a hydrogen atom; or
PAGs in which R⁶ and R⁸ are a hydrogen atom and R⁷ and R⁹ are a methyl group; or
PAGs in which R⁶ and R⁸ are a hydrogen atom and R⁷ and R⁹ are an ethyl group; or
PAGs in which R⁶ and R⁸ are a hydrogen atom, R⁷ is a methyl group and R⁹ is an ethyl group; or
PAGs in which R⁶ and R⁸ are a hydrogen atom, R⁷ is an ethyl group and R⁹ is a methyl group; or
PAGs in which R⁶, R⁷ and R⁹ are a hydrogen atom and R⁸ is a methyl group; or
PAGs in which R⁶, R⁸ and R⁹ are a hydrogen atom and R⁷ is a methyl group.

For a preferred PAG of the invention, R¹ is a straight-chain or branched C₈-C₁₂-alkyl group, R⁶, R⁸ and R⁹ are a hydrogen atom and R⁷ is a methyl group, p is an integer ranging from 3 to 5, for example 4,5, and q is an integer ranging from 1 to 3, for example 2.

For a more preferred PAG of the invention, R¹ is a straight-chain or branched C₈-C₁₂-alkyl group, R⁶ is a hydrogen atom and R⁷ is a methyl group, R⁸ is a hydrogen atom and R⁹ is an ethyl group, p is an integer ranging from 3 to 8, for example 5, and q is an integer ranging from 3 to 8, for example 4.

More preferably, the PAG of the composition of the invention is a block polymer of formula (II) or a statistical polymer of formula (II):

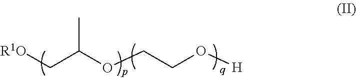

where:
R¹ is a straight-chain or branched C₈-C₁₂-alkyl group;
p is an integer ranging from 4 to 5;
q is an integer ranging from 2 to 3.

Further preferably, the PAG of the composition of the invention is a block polymer of formula (III) or a statistical polymer of formula (III):

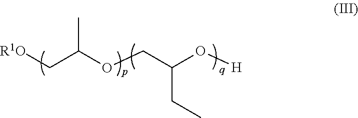

where:
R¹ is a straight-chain or branched C₈-C₁₂-alkyl group;
p is an integer ranging from 2 to 6;
q is an integer ranging from 2 to 5.

The PAG used for the composition of the invention can be prepared by reaction of at least one initiator of alcohol type having 1 to 30 carbon atoms with the epoxy bond of one or more alkylene oxides followed by propagation of the reaction allowing these polymers to be obtained. The preferred alkylene oxides are ethylene oxide, propylene oxide and butylene oxide. Methods for preparing PAG are described in international patent application WO-2012/070007 or in international patent application WO-2013/164449.

In addition to a base oil and a PAG, the monophasic lubricating composition of the invention comprises a phase-change material. Preferably, the phase-change material is a material with liquid-gas phase change.

Also preferably, the phase-change material has an enthalpy of vaporization or latent heat of vaporization, measured at 100° C. and under 0.101 MPa, ranging from 800 to 3 500 kJ/kg, preferably 1 000 to 2 500 kJ/kg.

One preferred example of phase-change material has an enthalpy of vaporization of 2257 kJ/kg, measured at 100° C. and under 0.101 MPa.

Also preferably, the phase-change material has a boiling point at normal pressure ranging from 50 to 150° C., preferably 90 to 120° C.

According to the invention, as examples of phase-change material, preference is given to the use of a material selected from among water, carboxylic acids, ethers, alcohols, in particular short-chain alcohols and particularly C₁-C₈ alcohols. According to the invention the preferred phase-change material is water.

Advantageously, the monophasic lubricating composition of the invention may comprise 0.001 to 0.6% by weight of phase-change material relative to the weight of the lubrication composition. Preferably, the monophasic lubricating composition of the invention may comprise 0.01 to 0.3% by weight of phase-change material relative to the weight of the lubricating composition. Preferably, the monophasic lubricating composition of the invention may therefore contain up to 0.6% by weight of water.

Also advantageously, the monophasic lubricating composition of the invention may comprise 0.5 to 2% by weight of phase-change material relative to the amount of PAG.

Also advantageously, the monophasic lubricating composition of the invention may comprise 1 to 30% by weight of a mixture of a phase-change material and PAG, relative to total lubricating composition weight. Preferably, the monophasic lubricating composition of the invention may comprise 2 to 20% by weight of a mixture of phase-change material and PAG, relative to total lubricating composition weight. More preferably the monophasic lubricating composition of the invention may comprise 5 to 15% by weight of a mixture of phase-change material and PAG, relative to total lubricating composition weight.

The monophasic lubricating composition of the invention comprises a PAG and a phase-change material. It also comprises a base oil. In general, the monophasic lubricating composition of the invention may comprise any type of mineral, synthetic or natural, animal or vegetable lubricating base oil adapted to use thereof.

The base oils used in the lubricating compositions of the invention may therefore be oils of mineral or synthetic origin belonging to Groups I to V of the API classification (or the equivalents thereof in the ATIEL classification) (Table A) or mixtures thereof.

TABLE A

| | Saturates | Sulphur | Viscosity index |
|---|---|---|---|
| | content | content | (VI) |
| Group I | <90% | >0.03% | 80 ≦ VI < 120 |
| Mineral oils | | | |
| Group II | ≧90% | ≦0.03% | 80 ≦ VI < 120 |
| Hydrocracked oils | | | |
| Groupe III | ≧90% | ≦0.03% | ≧120 |
| Hydrocracked or | | | |
| hydroisomerized oils | | | |

| | |
|---|---|
| Group IV | Polyalphaolefins (PAOs) |
| Group V | Esters and other bases not |
| | included in Groups I to IV. |

The mineral base oils that can be used for the monophasic lubricating composition of the invention include any type of base obtained by atmospheric and vacuum distillation of crude oil, followed by refining operations such as solvent extraction, deasphalting, solvent de-waxing, hydrotreatment, hydrocracking, hydroisomerization and hydrofinishing. Mixtures of synthetic and mineral oils can also be used.

There is generally no limit as to the use of different lubricating bases to produce the lubricating compositions of the invention, other than that they must have properties in particular of viscosity, viscosity index, sulphur content and oxidation resistance that are adapted for use in particular in engines or vehicle transmissions.

The base oils of the lubricating compositions of the invention can also be selected from among synthetic oils such as some esters of carboxylic acids and alcohols, and from among polyalphaolefins. The polyalphaolefins used as base oils are obtained for example from monomers having 4 to 32 carbon atoms e.g. from octene or decene, and having a viscosity at 100° C. of between 1.5 and 15 mm².s⁻¹ as per standard ASTM D445. Their molecular weight average is generally between 250 and 3 000 as per standard ASTM D5296.

Advantageously, according to the invention, the base oil can be selected from among Group III oils, Group IV oils and Group V oils. Preferably, the base oil is a Group III oil or Group V oil. As preferred Group V oil for the monophasic lubricating composition of the invention, mention can be made of polyalkylene glycols (PAGs) and in particular the oils of formula (IV) which are block polymers or statistical polymers:

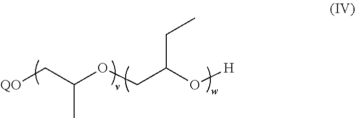

where:
Q is a straight-chain C₈-C₁₄-alkyl group;
v is an integer ranging from 2 to 6, preferably 2 to 4;
w is an integer ranging from 2 to 5, preferably 2 to 3.

The monophasic lubricating composition of the invention may also comprise another base oil. This other base oil can be selected from among Group III oils, Group IV oils and Group V oils.

Advantageously, the monophasic lubricating composition of the invention comprises at least 50% by weight of base oils relative to the total weight of the composition. More advantageously, the monophasic lubricating composition of the invention comprises at least 60 weight %, even at least 70 weight % of base oils relative to the total weight of the composition. Further advantageously, the monophasic lubricating composition of the invention comprises 50, 60 or 70 to 99.9% by weight, or 50, 60 or 70 to 90% by weight of one or more base oils relative to the total weight of the composition.

The monophasic lubricating composition of the invention may also comprise at least one additive. Numerous additives can be used for the monophasic lubricating composition of the invention. The preferred additives for the monophasic lubricating composition of the invention are selected from among detergent additives, anti-wear additives, friction modifying additives, extreme-pressure additives, dispersants, pour point improvers, defoaming additives, thickeners and mixtures thereof. Preferably, the monophasic lubricating composition of the invention comprises at least one anti-wear additive, at least one extreme-pressure additive or mixtures thereof. Anti-wear additives and extreme-pressure additives protect friction surfaces through the formation of a protective film adsorbed on these surfaces.

There exists a wide variety of anti-wear additives, Preferably, for the monophasic lubricating composition of the invention, the anti-wear additives are selected from among phospho-sulfurized additives such as metal alkylthiophosphates, in particular zinc alkylthiophosphates, and more specifically zinc dialkyldithiophosphates or ZnDTPs. The preferred compounds have the formula Zn((SP(S)(OR¹⁰)(OR¹¹))₂, where R¹⁰ and R¹¹, the same or different, are each independently an alkyl group, preferably an alkyl group having 1 to 18 carbon atoms.

Amine phosphates are also anti-wear additives that can be used in the monophasic lubricating composition of the invention. However, the phosphorus contributed by these additives may act as poison for catalytic systems of motor vehicles since these additives generate ash. These effects can be minimised by partly substituting amine phosphates by additives that do not contain phosphorus such as polysulfides for example, in particular sulfurized olefins.

Advantageously, the monophasic lubricating composition of the invention may comprise 0.01 to 6% by weight, preferably 0.05 to 4% by weight, more preferably 0.1 to 2% by weight of anti-wear additives and extreme-pressure additives relative to the total weight of lubricating composition.

Advantageously, the monophasic lubricating composition of the invention may comprise at least one friction modifying additive. The friction modifying additive can be selected from among a compound providing metal elements and an ash-free compound. Among the compounds providing metal elements, mention can be made of transition metal complexes such as Mo, Sb, Sn, Fe, Cu, Zn, the ligands of which may be hydrocarbon compounds comprising atoms of oxygen, nitrogen, sulfur or phosphorus. The ash-free friction modifying additives are generally or organic origin and can be selected from among the monoesters of fatty acids and polyols, alkoxylated amines, alkoxylated fatty amines, fatty epoxides, borate fatty epoxides; fatty amines or fatty acid glycerol esters. According to the invention the fatty compounds comprise at least one hydrocarbon group having 10 to 24 carbon atoms.

Advantageously, the monophasic lubricating composition of the invention may comprise 0.01 to 2% by weight, or 0.01 to 5% by weight, preferably 0.1 to 1.5% by weight or 0.1 to 2% by weight of friction modifying additives relative to the total weight of the lubricating composition.

Advantageously, the monophasic lubricating composition of the invention may comprise at least one antioxidant additive. An antioxidant additive generally allows delayed degradation of the lubricating composition in use. This degradation may notably translate as the formation of deposits, as the presence of sludge or as an increase in viscosity of the lubricating composition.

Antioxidant additives particularly act as radical inhibitors or hydroperoxide decomposers. Among the antioxidant additives frequently employed, mention can be made of antioxidant additives of phenolic type, antioxidant additives of amino type, phosphor-sulfurized antioxidant additives. Some of these antioxidant additives e.g. phospho-sulfurized antioxidant additives may generate ash. Phenolic antioxidant additives may be ash-free or may be in the form of neutral or basic metal salts. Antioxidant additives can be selected in particular from among sterically hindered phenols, sterically hindered phenol esters and sterically hindered phenols comprising a thioether bridge, diphenylamines, diphenylamines substituted by at least one C₁-C₁₂ alkyl group N,N′-dialkyl-aryl-diamines, and mixtures thereof.

Preferably, according to the invention, the sterically hindered phenols are selected from among compounds comprising a phenol group wherein at least one vicinal carbon of the carbon carrying the alcohol function is substituted by at least one C₁-C₁₀ alkyl group, preferably a C₁-C₆ alkyl group, preferably a C₄ alkyl group, preferably by the tert-butyl group.

Amino compounds are another class of antioxidant additives that can be used, optionally in combination with phenolic antioxidant additives. Examples of amino compounds are the aromatic amines e.g. the aromatic amines of formula NR^{a}R^{b}R^{c} where R^{a} is an aliphatic group or aromatic group, optionally substituted, R^{b} is an aromatic group, optionally substituted, R^{c} is a hydrogen atom, an alkyl group, an aryl group or a group of formula R^{d}S(O)_{z}R^{e} where R^{d} is an alkylene group or alkenylene group, R^{e} is an alkyl group, an alkenyl group or aryl group and z is 0, 1 or 2.

Sulfurized alkyl phenols or the alkaline or alkaline-earth metal salts thereof can also be used as antioxidant additives.

Another class of antioxidant additives is that of copper compounds e.g. copper thio- or dithio-phosphates, copper and carboxylic acid salts, copper dithiocarbamates, sulfonates, phenates and acetylacetonates. Copper I and II salts, the salts of succinic acid or anhydride can also be used.

The monophasic lubricating composition of the invention may contain any type of antioxidant additives known to persons skilled in the art.

Advantageously, the lubricating composition comprises at least one ash-free antioxidant additive.

Also advantageously, the monophasic lubricating composition of the invention comprises 0.5 to 2% by weight of at least one antioxidant additive relative to the total weight of the composition.

The monophasic lubricating composition of the invention may also comprise at least one detergent additive. Detergent additives generally allow a reduction in the formation of deposits on the surface of metal parts by dissolving secondary oxidation and combustion products.

The detergent additives that can be used in the monophasic lubricating composition of the invention may be anionic compounds comprising a long lipophilic hydrocarbon chain and hydrophilic head. The associated cation may be a metal cation of an alkaline or alkaline-earth metal. The detergent additives are preferably selected from among the salts of alkaline metals or alkaline-earth metals of carboxylic acids, sulfonates, salicylates, naphthenates, and phenate salts. The alkaline or alkaline-earth metals are preferably calcium, magnesium, sodium or barium. These metal salts generally comprise the metal in stoichiometric amount or in excess i.e. an amount greater than the stoichiometric amount. They are then overbased detergent additives; the excess metal imparting the overbased nature to the detergent additive is then generally in the form of an oil-insoluble metal salt e.g. a carbonate, hydroxide, an oxalate, acetate, glutamate, preferably a carbonate.

Advantageously, the monophasic lubricating composition of the invention may comprise 2 to 4% by weight of detergent additive relative to the total weight of the lubricating composition.

Also advantageously, the monophasic lubricating composition of the invention may further comprise at least one pour point depressant additive.

By slowing the formation of paraffin crystals, pour point depressants generally improve the behaviour of the monophasic lubricating composition of the invention under cold temperatures.

As examples of pour point depressant additives, mention can be made of alkyl polymethacrylates, polyacrylates, polyarylamides, polyalkylphenols, polyalkylnaphthalenes, alkylated polystyrenes.

Advantageously the monophasic lubricating composition of the invention may also comprise at least one dispersant. The dispersant can be selected from among Mannich bases, succinimides and derivatives thereof.

Also advantageously, the monophasic lubricating composition of the invention may comprise 0.2% to 10% by weight of dispersant relative to the total weight of the lubricating composition.

Advantageously, the lubricating composition may also comprise at least one additional polymer to improve the viscosity index. As examples of additional polymer to improve the viscosity index, mention can be made of polymer esters, homopolymers or copolymers, hydrogenated or non-hydrogenated, styrene, butadiene and isoprene, polymethacrylates (PMAs).

Also advantageously, the monophasic lubricating composition of the invention may comprise 1 to 15% by weight of oil-soluble polymer selected from among polyalkylene-glycols (PAGs), and of this additional viscosity index-improving polymer, relative to the total weight of the lubricating composition.

The lubricating composition of the invention can be prepared following a method comprising:
preparing a mixture or a solution comprising an oil selected from among polyalkylene glycols (PAGs), and a phase-change material;
adding this mixture or this solution to a base oil.

The particular, advantageous or preferred characteristics of the base oil, PAG or phase-change material of the monophasic lubricating composition of the invention define methods of the invention. By analogy, these methods form particular, advantageous or preferred methods of the invention.

The monophasic lubricating composition of the invention and the monophasic lubricating composition prepared with the preparation method of the invention are particularly advantageous for the lubrication of mechanical parts subjected to major heating in an engine. Therefore, the monophasic lubricating composition of the invention is advantageously used in compressor fluids, in hydraulic fluids, in greases, in turbine fluids, in gear lubricants or in lubricants for motor vehicle engines. It can particularly be given use to lubricate motor vehicle engines.

Preferably, the monophasic lubricating composition of the invention is used for lubrication of a motor vehicle engine. When in use, the monophasic lubricating composition of the invention is therefore placed in contact with at least one engine part.

Particularly advantageously, the use of a monophasic lubricating composition of the invention allows engine fouling to be reduced. It can also allow a reduction in the amount of coking products inside an engine.

This use of a monophasic lubricating composition of the invention is therefore of particular advantage to improve engine cleanliness, in particular to improve the cleanliness of the engine pistons.

The invention also concerns the use of a phase-change material defined by the invention as thermal agent in a monophasic engine lubricating composition. The use of a phase-change material as thermal agent in a monophasic lubricating composition of the invention is also part of the invention.

The invention also concerns the use of a mixture or of a solution of an oil selected from among polyalkylene glycols (PAGs) defined by the invention, and of a phase-change material defined by the invention as thermal agent in a monophasic engine lubricating composition, or as thermal agent in a monophasic lubricating composition defined by the invention.

The different aspects of the invention can be illustrated by the following examples.

### EXAMPLE 1

### Preparation of a Lubricating Composition (CL-1) of the Invention Comprising Water and a PAG (PAG-1)

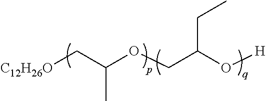

PAG-1: R¹=straight-chain alkyl derived from a C_{12,1} alcohol p=5.1 q=3.9

A monophasic lubricating composition of the invention (CL-1) was prepared from a mixture of water and a polyalkylene-glycol (PAG-1: commercial product Ucon OSP 32 produced by Dow) by mixing 1 g of water in 99 g of PAG-1. PAG-1 was prepared according to the method in Example 1 of international patent application WO-2013/164449 and comprises about 57 weight % of propylene oxide repeating units and about 43 weight % of butylene oxide repeating units. Its mean molar mass (measured as per standard ASTM D4274) is about 760 g.mol⁻¹, its viscosity measured at 40° C. (as per standard ASTM D445) is 32 mm².s⁻¹, its viscosity measured at 100° C. (as per standard ASTM D445) is 6.1 mm².s⁻¹ and its viscosity index (measured as per standard ASTM D2270) is 149.

15 g of a mixture of water and PAG-1 were then added to a formulated engine oil comprising: 13.3% additive package marketed under the name P6660 by Infineum, 5.3% hydrogenated polydiene polymer marketed under the name SV261 by Infineum, 0.3% PPD (Pour Point Depressant) marketed under the name LZ7748 by Lubrizol and 81.1% Group III base oils marketed under the name Nexbase 3043 (78%) and Nexbase 3050 (3.1%) by Neste.

### EXAMPLE 2

### Preparation of a Lubricating Composition of the Invention (CL-2) Comprising Water and a PAG (PAG-2)

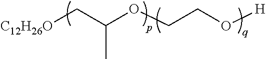

PAG-2: R¹=straight-chain alkyl derived from a C_{11,9} alcohol p=4.4 q=2.2

A monophasic lubricating composition of the invention (CL-2) was prepared from a mixture of water and a polyalkylene-glycol (PAG-2: commercial product Dowfax 20A42EB by Dow) by mixing 1 g of water in 99 g of PAG-2. PAG-2 comprises about 66 weight % of propylene oxide repeating units and about 34 weight % of ethylene oxide repeating units. Its mean molar mass (measured as per standard ASTM D4274) is about 535 g.mol⁻¹, its viscosity at 40° C. (as per standard ASTM D445) is 32 mm².s⁻¹, its viscosity measured at 100° C. (as per standard ASTM D445) is 7 mm².s⁻¹ and its viscosity index (measured as per standard ASTM D2270) is 189.

14 g of a mixture of water and PAG-2 were then added to a formulated engine oil comprising: 13.3% additive package marketed under the name P6660 by Infineum, 5.3% hydrogenated polydiene polymer marketed under the name SV261 by Infineum, 0.3% PPD (Pour Point Depressant) marketed under the name LZ7748 by Lubrizol and 81.1% Group III base oils marketed under the name Nexbase 3043 (78%) and Nexbase 3050 (3.1%) by Neste.

### EXAMPLE 3

### Preparation of a Comparative Lubricating Composition (CC-1) Comprising a PAG (PAG-1)

A comparative lubricating composition (CC-1) was prepared comprising: 13.3% additive package marketed under the name P6660 by Infineum, 5.3% hydrogenated polydiene polymer marketed under the name SV261 by Infineum, 0.3% PPD (Pour Point Depressant) marketed under the name LZ7748 by Lubrizol and 81.1% Group III base oils marketed under the name Nexbase 3043 (78%) and Nexbase 3050 (3.1%) by Neste. The PAG-1 was added in an amount of 15 weight % to the lubricating composition.

### EXAMPLE 4

### Preparation of a Comparative Lubricating Composition (CC-2) Comprising a PAG (PAG-2)

A comparative lubricating composition (CC-2) was prepared comprising: 13.3% additive package marketed under the name P6660 by Infineum, 5.3% hydrogenated polydiene polymer marketed under the name SV261 by Infineum, 0.3% PPD (Pour Point Depressant) marketed under the name LZ7748 by Lubrizol and 81.1% Group III base oils marketed under the name Nexbase 3043 (78%) and Nexbase 3050 (3.1%) by Neste. The PAG-2 was added in an amount of 14 weight % to the lubricating composition.

### EXAMPLE 5

Evaluation of the Properties of the Lubricating Compositions of the Invention (CL-1) and CL-2), of the properties of a reference lubricating composition (CR-1) and of Comparative Lubricating Compositions (CC-1 et CC-2)

The reference lubricating composition (CR-1) was formed of 13.3% additive package marketed under the name P6660 by Infineum, 5.3% hydrogenated polydiene polymer marketed under the name SV261 by Infineum, 0.3% PPD (Pour Point Depressant) marketed under the name LZ7748 by Lubrizol and 81.1% Group III base oils marketed under the name Nexbase 3043 (78%) and Nexbase 3050 (3.1%) by Neste.

Each lubricating composition (10 Kg) was evaluated with a motor vehicle cleanliness test for diesel engine with common rail injection. The engine displacement was 1.4 L with 4 cylinders. Engine power was 80 kW. The cycle time length of the test was 96 hours alternating slow engine speed with a speed of 4 000 rpm. The temperature of the lubricating composition was 145° C. and the temperature of the water in the coolant system was 100° C. No oil change and no topping up with lubricating composition were carried out during the test. The fuel used was EN 590.

The test was conducted in two phases for a total time of 106 hours, with a first rinsing and run-in step for 10 hours and second step with the evaluated composition (4 kg), and finally an endurance step lasting 96 hours with the evaluated composition (4 kg).

Throughout the test, the physicochemical parameters of the lubricant were evaluated. Lubricant consumption during run-in and during the test were evaluated. Deposits on the engine pistons were also evaluated. The results obtained are given in Table 1:

TABLE 1
Piston cleanliness merit rating after test

| Evaluated | Piston cleanliness merit |
|---|---|
| composition | rating after test (%) |
| CL-1 | 79.6 |
| CC-1 | 70.4 |
| CL-2 | 68.1 |
| CC-2 | 65 |
| CR-1 | 63 |

It can be seen that the lubricating compositions of the invention (CL-1 and CL-2) allow a signification gain in engine cleanliness compared with the comparative lubricating compositions (CC-1 and CC-2). With the lubricating compositions of the invention, the piston cleanliness merit rating after the test is much higher than the rating of the reference lubricating composition (CR-1).

It was also found that the lubricating compositions of the invention are stable.

1-13. (canceled)

14. A monophasic lubricating composition suitable for lubrication of an engine, comprising:
a base oil,
an oil selected from among polyalkylene glycols (PAGs), and 0.1 to 5 weight % of phase-change material relative to the amount of PAG.

15. The monophasic lubricating composition according to claim 14, wherein the composition comprises:
a base oil and a mixture of an oil selected from among PAGs with a phase-change material; or
a base oil and a solution of an oil selected from among PAGs with a phase-change material.

16. The monophasic lubricating composition according to claim 14, wherein the PAG is a block polymer of formula (I) or a statistical polymer of formula (I): 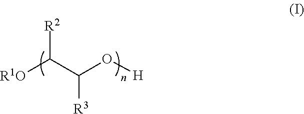
where:
R¹ is a straight-chain or branched C₁-C₃₀-alkyl group;
n is an integer ranging from 2 to 60;
R² and R³, the same or different, are each independently a hydrogen atom or C₁-C₂-alkyl group.

17. The monophasic lubricating composition according to claim 14, wherein the PAG is selected from among:
a block polymer of formula (IA) or a statistical polymer of formula (IA): 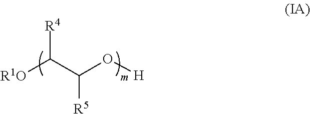
where:
R¹ is a straight-chain or branched C₁-C₃₀-alkyl group;
m is an integer ranging from 2 to 60;
R⁴ and R⁵ are a hydrogen atom; or R⁴ is a hydrogen atom and R⁵ is a methyl group; or R⁴ is a methyl group and R⁵ is a hydrogen atom; or R⁴ and R⁵ are a methyl group; or R⁴ is an ethyl group and R⁵ is a hydrogen atom; or R⁴ is a hydrogen atom and R⁵ is an ethyl group;
a block polymer of formula (IB) or a statistical polymer of formula (IB): 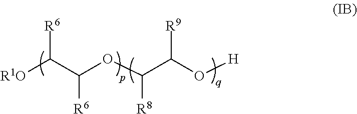
where:
R¹ is a straight-chain or branched C₁-C₃₀-alkyl group;
p and q are each independently an integer ranging from 1 to 30;
R⁶ and R⁷ are a hydrogen atom; or R⁶ is a hydrogen atom and R⁷ is a methyl group; or R⁶ is a methyl group and R⁷ is a hydrogen atom; or R⁶ and R⁷ are a methyl group; or R⁶ is an ethyl group and R⁷ is a hydrogen atom; or R⁶ is a hydrogen atom and R⁷ is an ethyl group;
R⁸ and R⁹ are a hydrogen atom; or R⁸ is a hydrogen atom and R⁹ is a methyl group; or R⁸ is a methyl group and R⁹ is a hydrogen atom; or R⁸ and R⁹ are a methyl group; or R⁸ is an ethyl group and R⁹ is a hydrogen atom; or R⁸ is a hydrogen atom and R⁹ is an ethyl group.

18. The monophasic lubricating composition according to claim 14, wherein the PAG is selected from among:
a block polymer of formula (II) or a statistical polymer of formula (II): 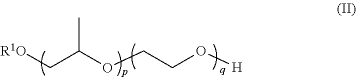
where:
R¹ is a straight-chain or branched C₈-C₁₂-alkyl group;
p is an integer ranging from 4 to 5;
q is an integer ranging from 2 to 3; or
a block polymer of formula (III) or a statistical polymer of formula (III): 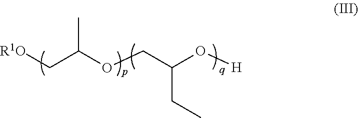
where:
R¹ is a straight-chain or branched C₈-C₁₂-alkyl group;
p is an integer ranging from 2 to 6;
q is an integer ranging from 2 to 5.

19. The monophasic lubricating composition according to claim 14, wherein the phase-change material has a liquid-gas phase change.

20. The monophasic lubricating composition according to claim 14, wherein the phase-change material has an enthalpy of vaporization or latent heat of vaporization, measured at 100° C. and under 0.101 MPa, ranging from 800 to 3 500 kJ/kg.

21. The monophasic lubricating composition according to claim 14, wherein the phase-change material has a boiling point at normal pressure ranging from 50 to 150° C.

22. The monophasic lubricating composition according to claim 14, wherein the phase-change material is selected from among water, carboxylic acids, ethers, alcohols, short-chain alcohols, C₁-C₈ alcohols.

23. The monophasic lubricating composition according to claim 14, wherein the composition comprises 0.5 to 2 weight % of phase-change material relative to the amount of PAG.

24. The monophasic lubricating composition according to claim 14, wherein the composition comprises 1 to 30 weight % of phase-change material and PAG relative to the total amount of lubricating composition.

25. The monophasic lubricating composition according to claim 14, wherein the composition is prepared with a method comprising:
preparing a mixture or a solution comprising an oil selected from among polyalkylene glycols (PAGs), and a phase-change material;
adding this mixture or this solution to a base oil.

26. A method for lubrication of a motor vehicle engine, comprising:
providing the monophasic lubricating composition of claim 14; and
applying the monophasic lubricating composition to internal surfaces of the motor vehicle engine.
